(19) United States
(12) Patent Application Publication
(10) Pub. No.: US 2015/0281461 A1
(43) Pub. Date: Oct. 1, 2015

(54) DYNAMIC NOTIFICATION DURING A TELECONFERENCE

(71) Applicant: International Business Machines Corporation, Armonk, NY (US)

(72) Inventors: Christopher J. Paul, Waxhaw, NC (US); Martin J.C. Presler-Marshall, Chapel Hill, NC (US)

(73) Assignee: International Business Machines Corporation, Armonk, NY (US)

(21) Appl. No.: 14/229,223

(22) Filed: Mar. 28, 2014

(51) Int. Cl. H04M 3/56

(52) U.S. Cl. CPC H04M 3/567; H04M 3/563

(57) ABSTRACT

In a method for sending a teleconference notification to one or more client devices connected to a teleconference an indication is received to send a teleconference notification to one or more client devices connected to a teleconference. One or more processors determine that a first client device of the one or more client devices is not an audio only device. In response to determining that the first client device of the one or more client devices is not an audio only device, one or more processors cause a non-audio notification of the teleconference notification to be sent to the first client device.

### TECHNICAL FIELD

The present invention relates generally to a method, system, and computer program product for managing notifications during a teleconference, and more specifically to a method, system, and computer program product for sending a teleconference notification to one or more client devices connected to a teleconference.

### BACKGROUND

Teleconferencing is a form of audio voice communication over a network. The network may be a local area network (LAN), a wide area network (WAN) such as the Internet, the public switched telephone network (PSTN), or any combination thereof. Typically, a teleconferencing service allocates one or more participant codes to invitees to a teleconference and connects each invitee to the teleconference based on the participant code entered by the invitee after he or she has dialed the call in number of the teleconference service.

A teleconference usually includes a host, who organizes or leads the conference, and a number of other invitees, also called guests. The host may often have additional privileges beyond those of the guests, such as, for example, being able to add or remove guests from the conference. The host may be distinguished from the guests by having a participant code that is different from the participant codes assigned to the guests.

### SUMMARY

Aspects of an embodiment of the present invention disclose a method, system, and a program product for sending a teleconference notification to one or more client devices connected to a teleconference. The method includes receiving an indication to send a teleconference notification to one or more client devices connected to a teleconference. The method further includes one or more processors determining that a first client device of the one or more client devices is not an audio only device. The method further includes, in response to determining that the first client device of the one or more client devices is not an audio only device, one or more processors causing a non-audio notification of the teleconference notification to be sent to the first client device.

### BRIEF DESCRIPTION OF THE SEVERAL VIEWS OF THE DRAWINGS

FIG. 1 depicts a diagram of a computing system in accordance with one embodiment of the present invention.

FIG. 2 depicts a use-case scenario in accordance with one embodiment of the present invention.

FIG. 3 depicts a flowchart of the steps of a notification function executing within the computing system of FIG. 1, for sending a teleconference notification to one or more client devices connected to a teleconference, in accordance with one embodiment of the present invention.

FIG. 4 depicts a block diagram of components of a server computing device of FIG. 1 in accordance with one embodiment of the present invention.

### DETAILED DESCRIPTION

The present invention will now be described in detail with reference to the figures.

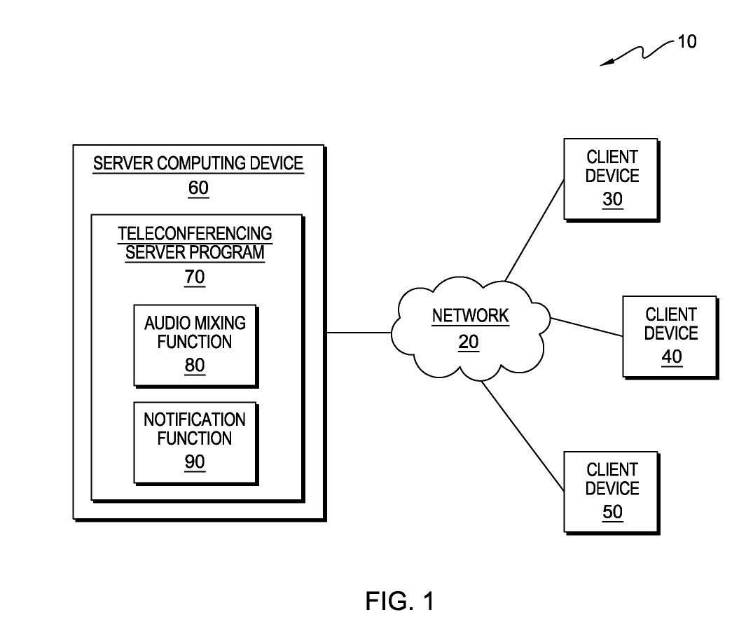

FIG. 1 depicts a diagram of computing system 10 in accordance with one embodiment of the present invention. FIG. 1 provides only an illustration of one embodiment and does not imply any limitations with regard to the environments in which different embodiments may be implemented.

In the depicted embodiment, computing system 10 includes client device 30, client device 40, client device 50, and server computing device 60 interconnected over network 20. Network 20 may be a local area network (LAN), a wide area network (WAN) such as the Internet, the public switched telephone network (PSTN), a private branch exchange (PBX), any combination thereof, or any combination of connections and protocols that will support communications between client device 30, client device 40, client device 50, and server computing device 60 in accordance with embodiments of the invention. Network 20 may include wired, wireless, or fiber optic connections. Computing system 10 may include additional server computing devices, client devices, or other devices not shown.

Client devices 30, 40, and 50 may be each individually be a plain old telephone service (POTS) telephone, voice over internet protocol (VoIP) telephone, cellular telephone, smart phone, or computing device implementing a telephony application. In general, client devices 30, 40, and 50 may each individually be any device or computing system capable of communicating with server computing device 60 over network 20.

Depending on the method of connection to server computing device 60, the client devices may have only an audio data connection or a multiple connections that include a supplemental data connection in addition to an audio data connection. In general, a client device that connects to server computing device 60 through the PSTN will have an audio data only connection. A client device that connects to server computing device 60 through a LAN, a WAN such as the Internet, any combination thereof, or any other internet protocol (IP) based connection will have a supplemental data connection in addition to an audio data connection. A client device that connects to server computing device 60 through a LAN, a WAN such as the Internet, any combination thereof, or any other IP based connection may include a client program for communicating with teleconferencing server program 70 over network 20.

A client program may be a standalone telephony client program or be part of a larger unified communications client program. The client program may execute on client devices 30, 40, and/or 50. The client program operates to provide a user interface for conducting teleconferences and for receiving teleconference notifications from server computing device 60 over network 20.

Server computing device 60 may be a management server, a web server, or any other electronic device or computing system capable of receiving and sending data. In other embodiments, server computing device 60 may represent a server computing system utilizing multiple computers as a server system, such as in a cloud computing environment. Server computing device 60 contains teleconferencing server program 70, audio mixing function 80, and notification program 90.

Teleconferencing server program 70 operates to manage teleconferences between invitees who connect to a teleconference service. At a scheduled date and time for the meeting, invitees call a teleconference number that may be listed in the teleconference invitation or connect to teleconferencing server program 70 over network 20 using a client program. In one embodiment, teleconferencing server program 70 resides on server computing device 60. In other embodiments, teleconferencing server program 70 may reside on another server or another computing device, provided that teleconferencing server program 70 is accessible to client devices 30, 40, and 50.

Audio mixing function 80 operates to generate a unique audio stream for each client device (e.g., client devices 30, 40, and 50) connected to a teleconference. Audio mixing function 80 also operates to send to each device the generated audio stream for that client device. The audio stream may be generated by mixing audio data received from one or more client devices connected to the teleconference. The audio stream may be in the form of audio data (digital) or analog signals able to interface with the PSTN depending on the client devices method of connection to server computing device 60. In one embodiment, audio mixing function 80 is a function of teleconferencing server program 70. In other embodiments, audio mixing function 80 may be a separate program or may be part of or reside in another program provided that audio mixing function 80 can communicate with teleconferencing server program 70 and client devices 30, 40, and 50.

Notification function 90 operates to send a teleconference notification to one or more client devices connected to a teleconference.

In one embodiment, notification function 90 causes one type of notification to be sent to one or more client devices connected to a teleconference that are audio only client devices and a different type of notification to one or more client devices that are not audio only client devices. In one embodiment, notification function 90 is a function of teleconferencing server program 70 on server computing device 60. In other embodiments, notification function 90 may be a separate program that resides on another server or another computing device, provided that notification function 90 is able to communicate with teleconferencing server program 70 and client devices 30, 40, and 50.

In one embodiment, an audio only client device is a client device that connects to server computing device 60 through the PSTN and has an audio data only connection to teleconferencing server program 70. A teleconference notification sent to an audio only device may be in the form of an audible notification mixed in to the audio stream sent to the audio only device using the audio data only connection between the audio only device and server computing device 60. Also, an audio only device may be able to interact with teleconferencing server program 70 over network 20 using a touch tone system such as Dual-tone multi-frequency signaling (DTMF). DTMF is used for telecommunication signaling over analog telephone lines (e.g., PSTN) in the voice-frequency band between telephone handsets and other devices. For example, after an audio only device is connected to teleconferencing server program 70 for a teleconference, the user of the audio only device may input a series of keys on the audio only devices keypad in order to interact with teleconferencing server program 70.

In one embodiment, teleconferencing server program 70 may provide an interface for an audio only device for a user to enable or disable teleconference options. For example, one teleconference option that may be provided by teleconferencing server program 70 is the ability for a user of an audio only device to disable audible teleconference notifications for only that audio only device. Because audio mixing function 80 operates to generate a unique audio stream for each client device connected to a teleconference, teleconferencing server program 70 may send a notification to audio mixing function 80 instructing it to not send audible teleconference notifications to an audio only device that elects to disable audible teleconference notifications.

In one embodiment, a client device that is not audio only is a client device that connects to server computing device 60 through a LAN, a WAN such as the Internet, any combination thereof, or any other internet protocol (IP) based connection and has a supplemental data connection in addition to the audio data connection to teleconferencing server program 70. A client device that connects to server computing device 60 through a LAN, a WAN such as the Internet, any combination thereof, or any other IP based connection may include a client program for communicating with teleconferencing server program 70 over network 20. A teleconference notification sent to a client device that is not an audio only device may be in the form of an indication sent to the client device that is not an audio only device using the supplemental data connection between the client device and server computing device 60. The indication may note the teleconference notification to be displayed to the client device. The indication is then interpreted and displayed by a client program to teleconferencing server program 70 operating on the client device that is not an audio only device.

In one embodiment, a client program to teleconferencing server program 70 may provide an interface on a client device that is not audio only for a user to customize how a teleconference notification will be displayed to the user. The client program for teleconferencing server program 70 may be written specifically for each type of device that it will operate on. For example, there may be a client program written for a desk top computer running Windows® and there may be a client program written for a smart phone. When a client program receives an indication of a teleconference notification, the teleconference notification is displayed on the client device depending on how a user has customized the client program. Customization may be limited depending on the capabilities of the type of client device. For example, a desk top will have different customization options than a smart phone.

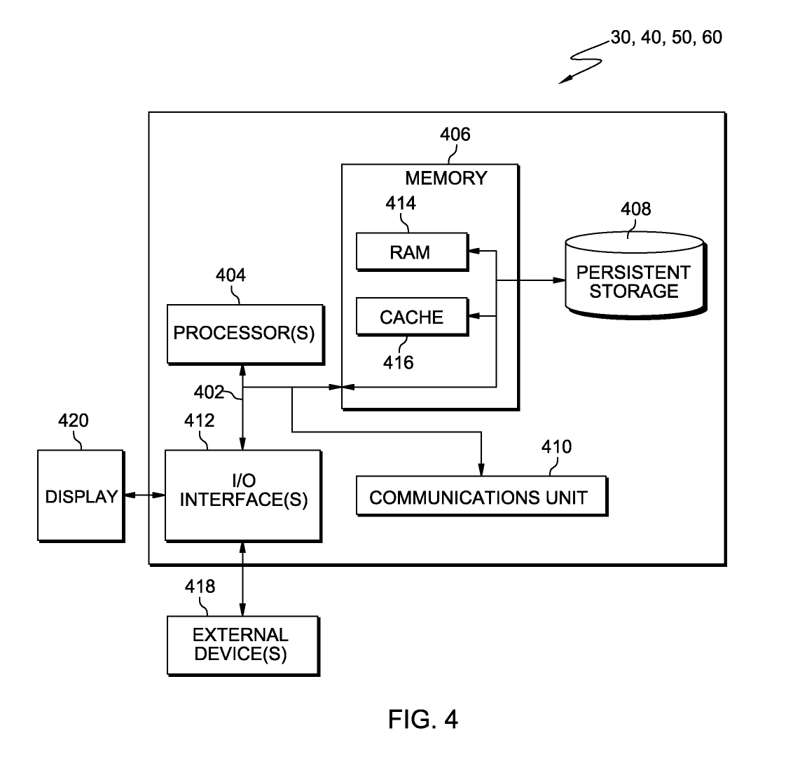

Server computing device 60 includes components as described in further detail with respect to FIG. 4. Client devices 30, 40, and 50 may also include components as described in further detail with respect to FIG. 4.

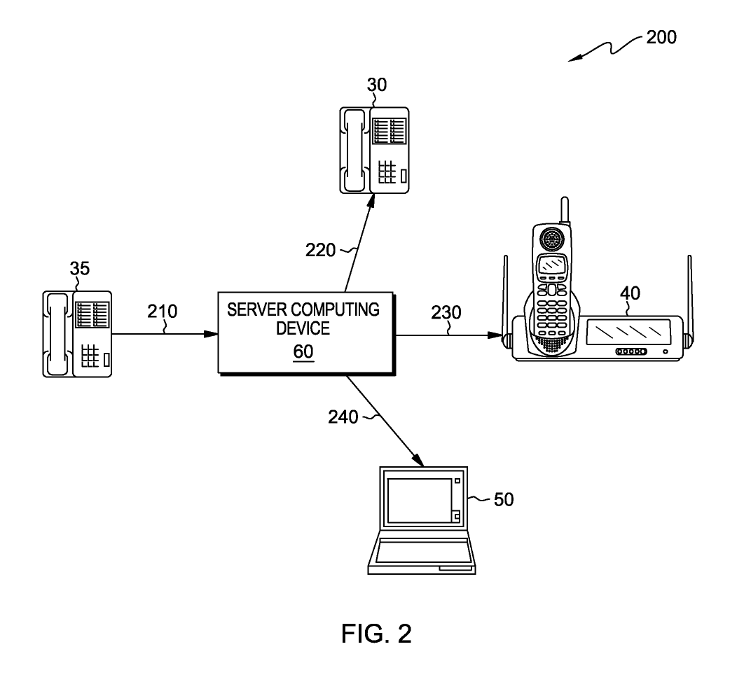

FIG. 2 depicts a use-case scenario 200 in accordance with one embodiment of the present invention. Scenario 200 depicts a user of client device 35, joining a teleconference already in session between the users of client devices 30, 40, and 50. Client device 35 is an audio only device (e.g., a POTS telephone). Client device 30 is also an audio only device (e.g., a POTS telephone). Client device 40 is a client device that is not an audio only device (e.g., a network telephone with a Liquid Crystal Display (LCD) screen). Client device 50 is also a client device that is not an audio only device (e.g., a laptop running a telephony program such as a client program to teleconferencing server program 70). Server computing device 60, utilizing teleconferencing server program 70, audio mixing function 80, and notification function 90, may act as the interface between client devices 30, 35, 40, and 50.

In scenario 200, client device 35 connects to an already active teleconference by placing call 210 to connect to server computing device 60 using a teleconference call-in number. Client device 35 is an audio only client device that connects to server computing device 60 through the PSTN and has an audio data only connection to teleconferencing server program 70. In response to receiving 210, teleconferencing server program 70 sends an indication, to notification function 90, to send a teleconference notification to the client devices already connected to the active teleconference (e.g., client devices 30, 40, and 50). In this scenario the teleconference notification is a notification to alert the already connected client devices that another client device has connected to the teleconference.

In response to receiving the indication to send the teleconference notification to the client devices already connected to the active teleconference, notification function 90 determines if each client device already connected to the active teleconference is an audio only device or not. In one embodiment, notification function 90 may send a request to teleconferencing server program 70 to determine if each client device already connected to the active teleconference is an audio only device or not. In one embodiment, teleconferencing server program 70 may determine if a client device is an audio only device or not based on the method of connection used by the client device to connect to server computing device 60. In general, a client device that connects to server computing device 60 through the PSTN will have an audio data only connection. A client device that connects to server computing device 60 through a LAN, a WAN such as the Internet, any combination thereof, or any other internet protocol (IP) based connection will have a supplemental data connection in addition to an audio data connection. Teleconferencing server program 70 sends an indication of whether each device connected to the active teleconference is an audio only device or not.

In response to receiving the indications, notification function 90 causes notifications 220, 230, and 240 to be sent to client devices 30, 40, and 50, respectively. In this scenario, because client device 30 is an audio only device (e.g., a POTS telephone), notification 220 is sent as an audible notification from audio mixing function 80 to client device 30 over the audio data only connection (e.g., PSTN). The audible notification will indicate to the user of client device 30 that client device 35 has joined the teleconference. The audible notification may be a sound or a prerecorded announcement. In this scenario, because client device 40 is not an audio only device (e.g., a network telephone with a Liquid Crystal Display (LCD) screen), notification 230 is sent as an indication from notification function 90 to client device 40 over the supplemental data connection (e.g., a LAN, a WAN such as the Internet, any combination thereof, or any other internet protocol (IP) based connection). The indication may note the teleconference notification to be displayed to the client device. The indication is then interpreted and displayed by a client program to teleconferencing server program 70 operating on client device 40. In this scenario, because client device 50 not an audio only device (e.g., a laptop a client program to teleconferencing server program 70), notification 240 is sent as an indication from notification function 90 to client device 50 over the supplemental data connection (e.g., a LAN, a WAN such as the Internet, any combination thereof, or any other internet protocol (IP) based connection). The indication may note the teleconference notification to be displayed to the client device. The indication is then interpreted and displayed by a client program to teleconferencing server program 70 operating on client device 50.

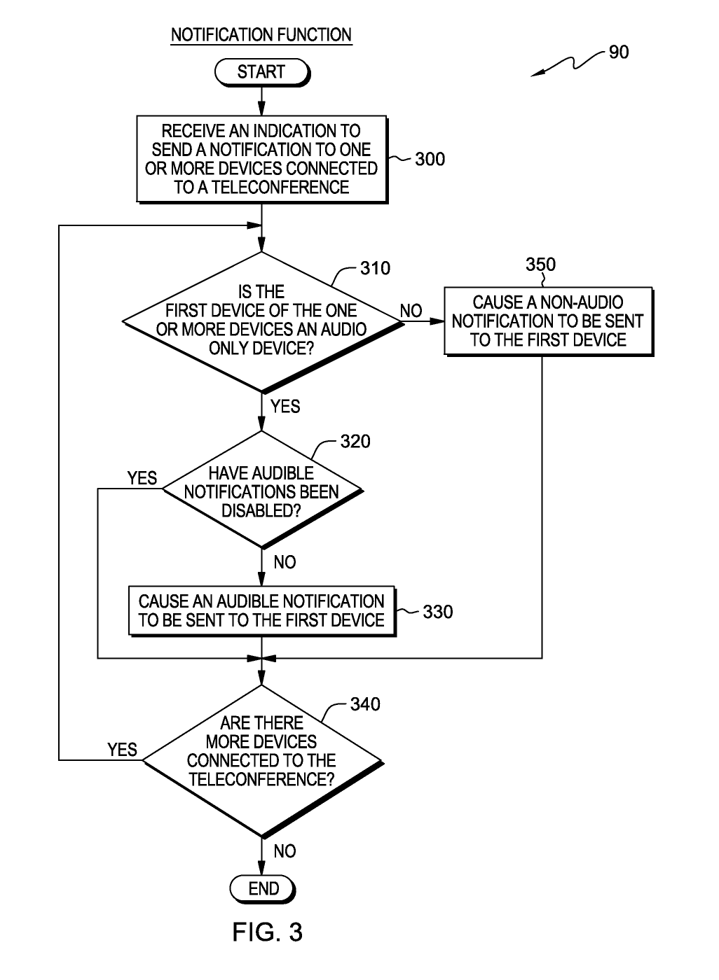

FIG. 3 depicts a flowchart of the steps of notification function 90 executing within the computing system of FIG. 1, for sending a teleconference notification to one or more client devices connected to a teleconference, in accordance with one embodiment of the present invention.

In one embodiment, initially, client devices 30, 40, and 50 are all connected to an active teleconference hosted by server computing device 60 running teleconferencing server program 70. For example, client device 30 is an audio only device connected to teleconferencing server program 70 on server computing device 60 over an audio data only connection (e.g., PSTN). Client device 40 is not an audio only device connected to teleconferencing server program 70 on server computing device 60 over a supplemental data connection (e.g., a LAN, a WAN such as the Internet, any combination thereof, or any other internet protocol (IP) based connection) and an audio data connection. Client device 50 is not an audio only device connected to teleconferencing server program 70 on server computing device 60 over a supplemental data connection (e.g., a LAN, a WAN such as the Internet, any combination thereof, or any other internet protocol (IP) based connection) and an audio data connection.

Client device 40 disconnects from the active teleconference hosted by server computing device 60 running teleconferencing server program 70. In response to client device 40 disconnecting from the active teleconference, teleconferencing server program 70 sends, to notification function 90, an indication to send a teleconference notification to the one or more client devices connected to the active teleconference. For example, the teleconference notification will indicate to the user of client devices 30 and 50 that client device 40 has disconnected from the active teleconference.

In step 300, notification function 90 receives the indication to send a teleconference notification to the one or more client devices connected to the active teleconference. In one embodiment, notification function 90 receives the indication to send a teleconference notification to the one or more client devices connected to the active teleconference from teleconferencing server program 70 after teleconferencing server program 70 has determined that client device 40 disconnects from the active teleconference.

In response to receiving the indication, notification function 90 determines if the first client device of the one or more client devices connected to the active teleconference is an audio only device (decision 310). Notification function 90 may determine if each client device of the one or more client devices connected to the active teleconference is an audio only device at the same time. In one embodiment, notification function 90 sends a request to teleconferencing server program 70 to determine if the first client device connected to the active teleconference is an audio only device or not. Notification function 90 receives an indication of whether the first client device connected to the active teleconference is an audio only device or not. For example, teleconferencing server program 70 determines that client device 30 is an audio only device and teleconferencing server program 70 sends an indication to notification function 90 noting that client device 30 is an audio only device.

If notification function 90 determines that the first client device of the one or more client devices connected to the active teleconference is an audio only device, (decision 310, yes branch), notification function 90 determines if audible notifications have been disabled for the first client device (decision 320). In one embodiment, notification function 90 sends a request to teleconferencing server program 70 to determine if audible notifications have been disabled for the first client device. In one embodiment, teleconferencing server program 70 may provide an interface for an audio only device for a user to enable or disable teleconference options. For example, one teleconference option that may be provided by teleconferencing server program 70 is the ability for a user of an audio only device to disable audible teleconference notifications for only that audio only device. If the user of client device 30 had previously used the interface provided by teleconferencing server program 70 to disable audible notifications, teleconferencing server program 70 will send an indication to notification function 90 noting that audible notifications have been disabled for client device 30. If the user of client device 30 had not previously used the interface provided by teleconferencing server program 70 to disable audible notifications, teleconferencing server program 70 will send an indication to notification function 90 noting that audible notifications have not been disabled for client device 30.

If notification function 90 determines that audible notifications have been disabled for the first client device, (decision 320, yes branch), notification function 90 proceeds to decision 340. If notification function 90 determines that audible notifications have not been disabled for the first client device, (decision 320, no branch), notification function 90 causes an audible notification to be sent to the first client device (step 330). In one embodiment, notification function 90 sends to audio mixing function 80 a request for audio mixing function 80 to generate a unique audio stream with the audible teleconference notification included for client device 30. Audio mixing function 80 then sends to client device 30 the mixed audio stream including the audible teleconference notification. The audio stream may be in the form of audio data (digital) or analog signals able to interface with the PSTN.

If notification function 90 determines that the first client device of the one or more client devices connected to the active teleconference is not an audio only device, (decision 310, no branch), notification function 90 causes a non-audio notification to be sent to the first client device (step 350). In one embodiment, notification function 90 sends, to a client program of teleconferencing server program 70 on client device 30, an indication of the teleconference notification. The indication may be sent to the client program of teleconferencing server program 70 on client device 30 over the supplemental data connection between client device 30 and server computing device 60. The indication may note the teleconference notification to be displayed to client device 30. The indication is then interpreted and displayed by the client program to teleconferencing server program 70 operating on client device 30 that is not an audio only device.

In decision 340, notification function 90 determines if there are more client devices connected to the active teleconference. In one embodiment, notification function 90 sends a request to teleconferencing server program 70 to determine if there are more client devices connected to the active teleconference. If notification function 90 determines that there are more client devices connected to the active teleconference, (decision 340, yes branch), notification function 90 proceeds to decision 310. Notification function 90 will then move on to a second client device of the one or more client devices connected to the active teleconference. In other embodiments, the determinations for all devices connected to the active teleconference will be done at the same time. If notification function 90 determines that there are no more client devices connected to the active teleconference, (decision 340, no branch), notification function 90 ends.

FIG. 4 depicts a block diagram of components of server computing device 60 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made. Client devices 30, 40, and 50 may also include components as described in herein.

Server computing device 60 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM) 414 and cache memory 416. In general, memory 406 can include any suitable volatile or non-volatile computer readable storage media.

Teleconferencing server program 70, audio mixing function 80, and notification function 90 are stored in persistent storage 408 for execution by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices, including client devices 30, 40, and 50. In these examples, communications unit 410 includes one or more network interface cards. Communications unit 410 may provide communications through the use of either or both physical and wireless communications links. Teleconferencing server program 70, audio mixing function 80, and notification function 90 may be downloaded to persistent storage 408 through communications unit 410.

I/O interface(s) 412 allows for input and output of data with other devices that may be connected to server computer 60. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention, e.g., teleconferencing server program 70, audio mixing function 80, and notification function 90, can be stored on such portable computer readable storage media and can be loaded onto persistent storage 408 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for sending a teleconference notification to one or more client devices connected to a teleconference, the method comprising the steps of:
receiving an indication to send a teleconference notification to one or more client devices connected to a teleconference;
one or more processors determining that a first client device of the one or more client devices is not an audio only device; and
in response to determining that the first client device of the one or more client devices is not an audio only device, one or more processors causing a non-audio notification of the teleconference notification to be sent to the first client device.

2. The method of claim 1, further comprising:
one or more processors determining that a second client device of the one or more client devices is an audio only device; and
in response to determining that the second client device of the one or more client devices is an audio only device, one or more processors determining if audible notifications have been disabled for the second client device.

3. The method of claim 2, further comprising:
in response to determining that audible notifications have been disabled for the second client device, one or more processors generating an audio stream without an audible notification of the teleconference notification for the second client device, wherein a unique audio stream is generated for each client device of the one or more client devices connected to the teleconference.

4. The method of claim 2, further comprising:
in response to determining that audible notifications have not been disabled for the second client device, one or more processors causing an audible notification of the teleconference notification to be sent to the second client device.

5. The method of claim 1, wherein the step of one or more processors determining that the first client device of the one or more client devices is not an audio only device comprises the step of one or more processors determining a method of connection of the first client device to the teleconference, wherein the method of connection is an internet protocol (IP) based connection.

6. The method of claim 2, wherein the step of one or more processors determining that the second client device of the one or more client devices is an audio only device comprises the step of one or more processors determining a method of connection of the second client device to the teleconference, wherein the method of connection is a Public Switched Telephone Network (PSTN) connection.

7. A computer program product for sending a teleconference notification to one or more client devices connected to a teleconference, the computer program product comprising:
one or more computer readable storage media and program instructions stored on the one or more computer readable storage media, the program instructions comprising:
program instructions to receive an indication to send a teleconference notification to one or more client devices connected to a teleconference;
program instructions to determine that a first client device of the one or more client devices is not an audio only device; and
program instructions, responsive to determining that the first client device of the one or more client devices is not an audio only device, to cause a non-audio notification of the teleconference notification to be sent to the first client device.

8. The computer program product of claim 7, further comprising:
program instructions, stored on the one or more computer readable storage media, to determine that a second client device of the one or more client devices is an audio only device; and
program instructions, stored on the one or more computer readable storage media, responsive to determining that the second client device of the one or more client devices is an audio only device, to determine if audible notifications have been disabled for the second client device.

9. The computer program product of claim 8, further comprising:
program instructions, stored on the one or more computer readable storage media, responsive to determining that audible notifications have been disabled for the second client device, to generate an audio stream without an audible notification of the teleconference notification for the second client device, wherein a unique audio stream is generated for each client device of the one or more client devices connected to the teleconference.

10. The computer program product of claim 8, further comprising:
program instructions, stored on the one or more computer readable storage media, responsive to determining that audible notifications have not been disabled for the second client device, to cause an audible notification of the teleconference notification to be sent to the second client device.

11. The computer program product of claim 7, wherein the program instructions to determine that the first client device of the one or more client devices is not an audio only device comprise program instructions to determine a method of connection of the first client device to the teleconference, wherein the method of connection is an internet protocol (IP) based connection.

12. The computer program product of claim 8, wherein the program instructions to determine that the second client device of the one or more client devices is an audio only device comprise program instructions to determine a method of connection of the second client device to the teleconference, wherein the method of connection is a Public Switched Telephone Network (PSTN) connection.

13. A computer system for sending a teleconference notification to one or more client devices connected to a teleconference, the computer system comprising:
one or more computer processors;
one or more computer readable storage media;
program instructions stored on the computer readable storage media for execution by at least one of the one or more processors, the program instructions comprising:
program instructions to receive an indication to send a teleconference notification to one or more client devices connected to a teleconference;
program instructions to determine that a first client device of the one or more client devices is not an audio only device; and
program instructions, responsive to determining that the first client device of the one or more client devices is not an audio only device, to cause a non-audio notification of the teleconference notification to be sent to the first client device.

14. The computer system of claim 13, further comprising:
program instructions, stored on the computer readable storage media for execution by at least one of the one or more processors, to determine that a second client device of the one or more client devices is an audio only device; and
program instructions, stored on the computer readable storage media for execution by at least one of the one or more processors, responsive to determining that the second client device of the one or more client devices is an audio only device, to determine if audible notifications have been disabled for the second client device.

15. The computer system of claim 14, further comprising:
program instructions, stored on the computer readable storage media for execution by at least one of the one or more processors, responsive to determining that audible notifications have been disabled for the second client device, to generate an audio stream without an audible notification of the teleconference notification for the second client device, wherein a unique audio stream is generated for each client device of the one or more client devices connected to the teleconference.

16. The computer system of claim 14, further comprising:
program instructions, stored on the computer readable storage media for execution by at least one of the one or more processors, responsive to determining that audible notifications have not been disabled for the second client device, to cause an audible notification of the teleconference notification to be sent to the second client device.

17. The computer system of claim 13, wherein the program instructions to determine that the first client device of the one or more client devices is not an audio only device comprise program instructions to determine a method of connection of the first client device to the teleconference, wherein the method of connection is an internet protocol (IP) based connection.

18. The computer system of claim 14, wherein the program instructions to determine that the second client device of the one or more client devices is an audio only device comprise program instructions to determine a method of connection of the second client device to the teleconference, wherein the method of connection is a Public Switched Telephone Network (PSTN) connection.
